(19) United States
(12) Patent Application Publication
(10) Pub. No.: US 2014/0342202 A1
(43) Pub. Date: Nov. 20, 2014

(54) BATTERY-COOLING SYSTEM FOR AN ELECTRIC VEHICLE

(71) Applicant: V-ENS CO., LTD., Gyeyang-gu Incheon (KR)

(72) Inventor: Tae Young Chang, Seoul (KR)

(73) Assignee: LG ELECTRONICS INC., Seoul (KR)

(21) Appl. No.: 14/365,956

(22) PCT Filed: Dec. 14, 2012
(86) PCT No.: PCT/KR2012/010950

§ 371 Date: Jun. 16, 2014

(30) Foreign Application Priority Data
Dec. 16, 2011 (KR) 1020110136484

(51) Int. Cl. H01M 10/625; H01M 10/6563

(52) U.S. Cl. CPC H01M 10/5016; H01M 10/5067; H01M 2220/20
USPC 429/71; 429/83

(57) ABSTRACT

According to the present invention, a battery-cooling system for an electric vehicle is configured such that the interior of a battery case is divided into a plurality of rooms, each of which has a cell module assembly mounted therein. Thus, airflows among a plurality of cell module assemblies may not affect one another, and air passes independently from each cell module assembly to the other within each room, thereby achieving improved cooling performance due to the independent airflows. Further, discharge ducts for each room may have respective suction fans, thus enabling the independent discharge of air from each cell module assembly and achieving improved cooling performance.

### TECHNICAL FIELD

The present invention relates to an electric vehicle and, more particularly, to a battery-cooling system for an electric vehicle which is capable of improving the battery cooling performance by ensuring smooth flow of air in the battery.

### BACKGROUND ART

Generally, a vehicle refers to a machine that travels using a power generator as a power source, and carries people or load or performs various operations. Vehicles can be classified according to types of power generator. Vehicles can be classified into a gasoline vehicle using a gasoline engine as the power generator, a diesel vehicle using a diesel engine as a power generator, a liquefied petroleum gas (LPG) vehicle using a liquefied petroleum gas as a fuel, a gas turbine vehicle using a gas turbine as the power generator, and an electric vehicle (EV) employing a motor as a power generator and uses electricity charged in a battery.

Vehicles using fossil fuels such as gasoline, diesel and LPG cause environmental problems due to exhaust gas, exhausting the petroleum resource. Accordingly, an electric vehicle that moves using electricity as power has emerged as an alternative to vehicles using fossil fuels.

An electric vehicle uses a drive motor which is driven by electricity supplied from a battery, and accordingly does not emit carbon dioxide gas. Therefore, it has come into the spotlight as an eco-friendly vehicle. Recently, development of electric vehicles has been spurred by soaring oil price and tightened emission regulations, and the market scale of electric vehicles has been rapidly increasing.

However, to exhibit high efficiency, the electric vehicle needs to be lightweight and compact. Accordingly, a method of efficiently cooling the interior of a compact battery which is demanded.

### DISCLOSURE

### Technical Problem

The object of the present invention is to provide a battery-cooling system for an electric vehicle which is capable of efficiently cooling a battery.

### Technical Solution

The object of the present invention can be achieved by providing a battery-cooling system for an electric vehicle including a battery provided with a battery case having an interior partitioned into a plurality of rooms, a cell module assembly being mounted in each of the rooms, and a battery-cooling unit to introduce cool air into each of the rooms and to separately suction the air from each of the rooms and discharge the suctioned air.

### Advantageous Effects

According to one embodiment of the present invention, a battery-cooling system for an electric vehicle has a battery case whose interior is partitioned into a plurality of rooms respectively provided with a cell module assembly. Accordingly, air flows in the cell module assemblies do not affect each other, and air independently passes through the respective rooms. Therefore, the cooing performance may be improved by the independent air flows.

In addition, the discharge ducts for each room is provided with suction fans, thereby enabling independent discharge of air from each cell module assembly and improving the cooling performance.

In addition, as suction fans are provided to the discharge ducts which guide discharge of air from the battery, flow resistance may be drastically reduced compared to the case in which suction fans are provided to the introduction ducts to introduce air into the battery. Thereby, smooth flow air may be ensured, and the cooling performance may be improved.

### DESCRIPTION OF DRAWINGS

FIG. 1 is a perspective view illustrating a battery-cooling system for an electric vehicle according to an exemplary embodiment of the present invention.

FIG. 2 is a plan view illustrating the battery-cooling system for an electric vehicle shown in FIG. 1.

FIG. 3 is a cross-sectional view taken along line A-A in FIG. 2.

FIG. 4 is a cross-sectional view taken along line B-B in FIG. 2.

FIG. 5 is a perspective view illustrating the interior of the battery cover shown in FIG. 2.

### BEST MODE

Hereinafter, a battery-cooling system for an electric vehicle according to an embodiment of the present invention will be described in detail with reference to the accompanying drawings.

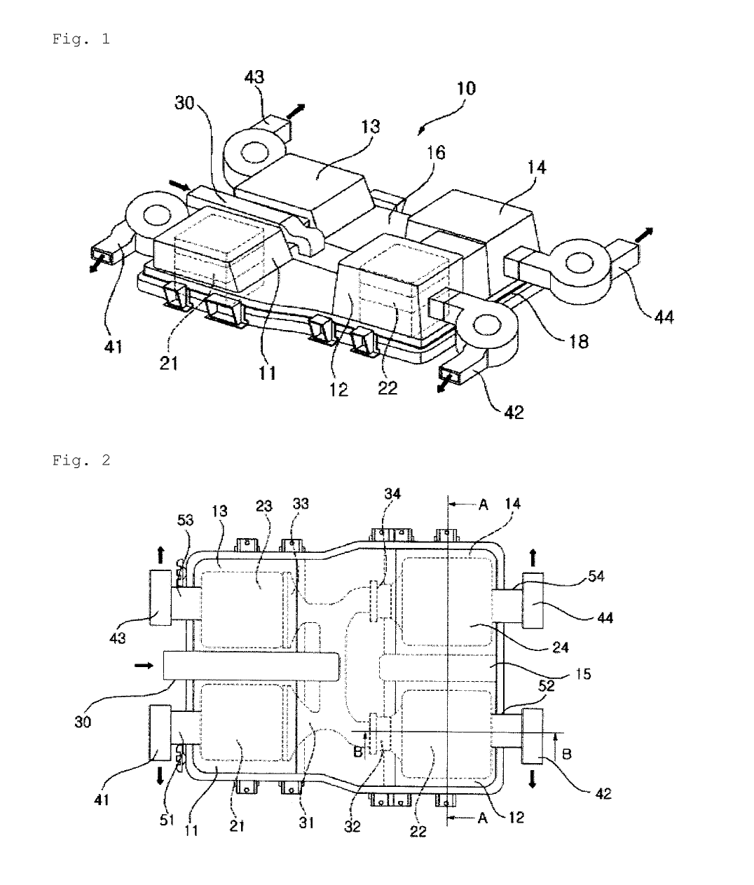

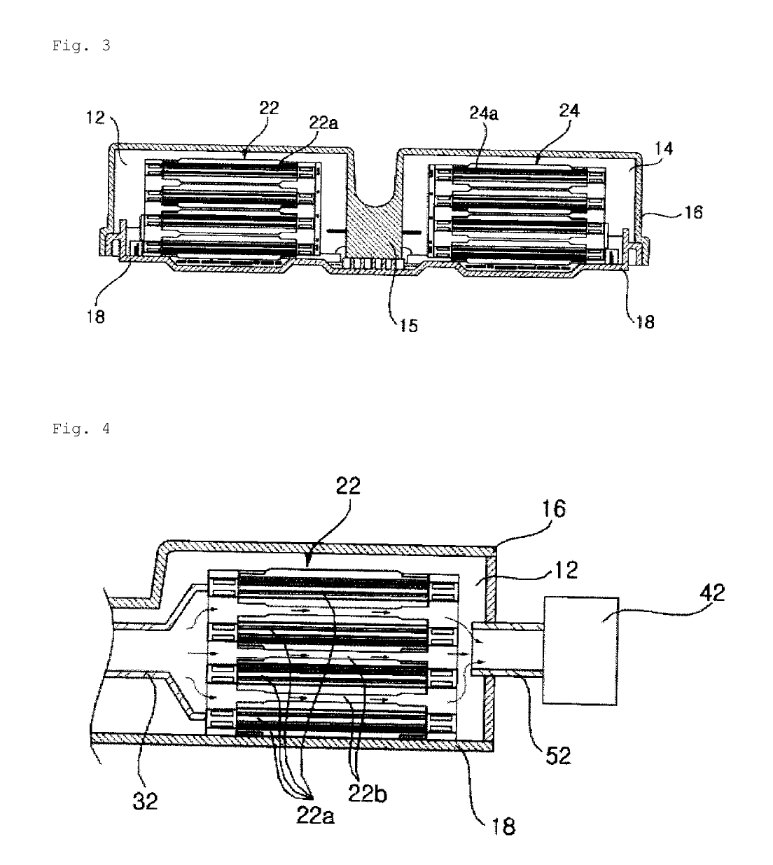

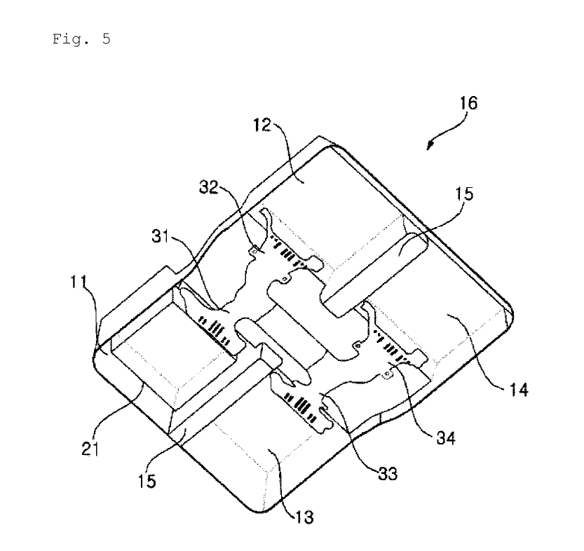

FIG. 1 is a perspective view illustrating a battery-cooling system for an electric vehicle according to an exemplary embodiment of the present invention. FIG. 2 is a plan view illustrating the battery-cooling system for an electric vehicle shown in FIG. 1. FIG. 3 is a cross-sectional view taken along line A-A in FIG. 2. FIG. 4 is a cross-sectional view taken along line B-B in FIG. 2.

Referring to FIGS. 1 and 2, the battery-cooling system for an electric vehicle according to this embodiment includes a battery 10 used as power source to supply electric power and internally partitioned into a plurality of rooms, and a battery-cooling unit to cool the interior of the battery 10.

The battery 10 is also called an energy storage module (ESM), and will be hereinafter simply referred to as a battery.

The battery 10 includes battery cases 16 and 18 forming the exterior of the battery and a plurality of cell module assemblies (CMAs) 21, 22, 23 and 24 provided in the battery cases 16 and 18.

Each of the CMAs 21, 22, 23 and 24, which generate electric current, includes a plurality of cell modules 22a and 24a which are vertically stacked. The cell modules may alternatively be stacked in the front-to-back direction or lateral direction.

The battery cases 16 and 18 include a battery carrier 18, on which the CMAs 21, 22, 23 and 24 are placed, and a battery cover 16 mounted to the upper side of the battery carrier 18 so as to surround the CMAs 21, 22, 23 and 24.

The battery carrier 18 may be joined to the floor of the vehicle body by, for example, a fastening member.

The battery cover 16 may be coupled with, for example, the battery-cooling unit.

FIG. 5 is a perspective view illustrating the interior of the battery cover shown in FIG. 2.

Referring to FIG. 5, the interior of the battery cover 16 is partitioned into a plurality of rooms 11, 12, 13 and 14 according to the number of the CMAs 21, 22, 23 and 24. In this embodiment, the plurality of CMAs 21, 22, 23 and 24 is constituted by first, second, third and fourth CMAs 21, 22, 23 and 24. Accordingly, the interior of the battery cover 16 exemplarily has four rooms, i.e., first, second, third and fourth rooms 11, 12, 13 and 14 in which the first, second, third and fourth CMAs 21, 22, 23 and 24 are respectively seated.

Referring to FIGS. 3 and 5, the first, second, third and fourth rooms 11, 12, 13 and 14 may be grooved convexly upward to allow the first, second, third and fourth CMAs 21, 22, 23 and 24 to be respectively seated thereon.

The interior of the battery cover 16 may be provided with a partition wall 15 to partition the interior into the first, second, third and fourth rooms 11, 12, 13 and 14. The partition wall 15 may be provided between the first room 11 and the third room 13 and between the second room 12 and the fourth room 14.

The battery-cooling unit includes introduction ducts 30, 31, 32, 33 and 34 to guide external air into the first, second, third and fourth rooms 11, 12, 13 and 14, discharge ducts 51, 52, 53 and 54 provided to the first, second, third and fourth rooms 11, 12, 13 and 14 respectively to discharge the air having cooled the first, second, third and fourth CMAs 21, 22, 23 and 24, and a plurality of suction fans 41, 42, 43 and 44 provided to the discharge ducts 51, 52, and 54 respectively to suction and discharge the air having cooled the first, second, third and fourth CMAs 21, 22, 23 and 24.

The introduction ducts include an external introduction duct 30 provided to the exterior of the battery cover 16 to guide external air into the battery cover 16 and first, second, third and fourth internal introduction ducts 31, 32, 33 and 34 connected to the external introduction duct 30 and provided in the battery cover 16 to be branched to be connected to the rooms 11, 12, 13 and 14. In this embodiment, one external introduction duct 30 is provided and four internal introduction ducts are provided and connected to the external introduction duct 30. However, embodiments of the present invention are not limited thereto. It is also possible to provide four external introduction ducts 30 to be individually connected to the rooms 11, 12, 13 and 14.

The external introduction duct 30 may be connected to the interior of the vehicle or an air conditioner configured to cool the interior of the vehicle. Thereby, it may guide the air cooled by the air conditioner into the battery 10, or may guide the cool air from the interior of the vehicle into the battery 10. The external introduction duct 30 may be connected to be positioned at the central portion between the first, second, third and fourth CMAs 21, 22, 23 and 24.

The first, second, third and fourth internal introduction ducts 31, 32, 33 and 34 are formed by branching the external introduction duct 30 into four parts. The first, second, third and fourth internal introduction ducts 31, 32, 33 and 34 may be respectively connected to the first, second, third and fourth rooms 11, 12, 13 and 14, or may be respectively connected to the first, second, third and fourth CMAs 21, 22, 23 and 24. In this embodiment, the first, second, third and fourth internal introduction ducts 31, 32, 33 and are assumed to be respectively connected to the first, second, third and fourth CMAs 21, 22, 23 and 24.

Each of the first, second, third and fourth CMAs 21, 22, 23 and 24 is provided with a plurality of cell modules which are vertically stacked. The cell modules are disposed to be spaced a predetermined distance from each other, and air flow passages are formed between the cell modules to allow air to flow therethrough.

For example, referring to FIG. 4, the second CMA 22 is provided with a plurality of cell modules 22a which are vertically stacked. The cell modules 22a are disposed to be spaced a predetermined distance from each other, air flow passages 22b are formed between the cell modules 22a to allow the air to flow therethrough.

Accordingly, the second internal introduction duct 32 is connected to the second room 12, and is coupled to the second CMA 22 so as to communicate with the air flow passages 22b. The air introduced through the second internal introduction duct 32 passes through the air flow passages 22b, cooling the interior of the second CMA 22.

Similarly, the first internal introduction duct 31 is coupled so as to communicate with a spacing space defined in the first CMA 21, the third internal introduction duct 33 may be coupled so as to communicate with the spacing space defined in the third CMA 23, and the fourth internal introduction duct 34 may be coupled so as to communicate with the air flow passage defined in the fourth CMA 24.

The discharge ducts include discharge ducts 51, 52, 53 and 54 connected to the first, second, third and fourth rooms 11, 12, 13 and 14, respectively.

The discharge ducts 51, 52, 53 and 54 are respectively connected to the first, second, third and fourth rooms 11, 12, 13 and 14 so as to discharge the air from the first, second, third and fourth rooms 11, 12, 13 and 14. However, embodiments of the present invention are not limited thereto. The discharge ducts 51, 52, 53 and 54 may be directly coupled to the first, second, third and fourth CMAs 21, 22, 23 and 24.

The suction fans include first, second, third and fourth suction fans 41, 42, 43 and 44 installed in the first, second, third and fourth discharge ducts 51, 52, 53 and 54, respectively.

As the first, second, third and fourth rooms 11, 12, 13 and 14 are respectively provided with the first, second, third and fourth discharge ducts 51, 52, 53 and 54 and the first, second, third and fourth suction fans 41, 42, 43 and 44, air may independently flow through the first, second, third and fourth rooms 11, 12, 13 and 14.

While the introduction duct is illustrated as being branched into plural parts in the battery 10 in the illustrated embodiment, embodiments of the present invention are not limited thereto. Plural introduction ducts may be arranged at the exterior of the battery case and separately coupled to plural rooms, respectively.

Hereinafter, operation of the present invention according to an embodiment configured as above will be described.

When the battery 10 needs to be cooled, the first, second, third and fourth suction fans 41, 42, 43 and 44 are drive respectively.

Once the first, second, third and fourth suction fans 41, 42, 43 and 44 are driven, external air is caused to flow toward the first, second, third and fourth suction fans 41, 42, 43 and 44 via the first, second, third and fourth CMAs 21, 22, 23 and 24 by the suction force of the first, second, third and fourth suction fans 41, 42, 43 and 44.

Hereinafter, a description will be exemplarily given of the case in which the second suction fan 42 is drive, with reference to FIG. 4.

Once the second suction fan 42 is driven, the external air is caused to pass through the air flow passages 22b in the second CMA 22 via the external introduction duct and the second internal introduction duct 32 by the suction force of the second suction fan 42.

Since the air flow passages 22b in the second CMA are narrow gaps, it is very difficult to forcibly introduce the external air into the air flow passages 22b. However, in this embodiment, the air in the air flow passages 22b is suctioned so as to flow to the second discharge duct 52 by the suction force of the second suction fan 42 provided to the second discharge duct 52. Therefore, the external air may readily pass through the air flow passages 22b.

While passing through the air flow passages 22b in the second CMA 22, the external air may cool the second CMA 22.

The air having passed through the second CMA 22 may enter the second room 12 and then be externally discharged through the second discharge duct 52 by the suction force of the second suction fan 42.

While the second suction fan 42 is being driven as above, the first suction fan 41 and the third and fourth suction fans 43 and 44 are also driven.

As the external air is caused to pass through the air flow passages in the first CMA 21 via the first internal introduction duct 31 by the suction force of the first suction fan 41, the external air cools the first CMA 21. The air having cooled the first CMA 21 by passing through the first CMA 21 flows into the first room 11 and is then discharged to the exterior through the first discharge duct 51.

By the suction force of the third suction fan 43, the external air passes through the air flow passages in the third CMA 23 via the third internal introduction duct 33, cooling the third CMA 23. The air having cooled the third CMA 23 by passing through the third CMA 23 flows into the third room 13, and is then discharged to the exterior through the third discharge duct 53.

By the suction force of the fourth suction fan 44, the external air passes through the air flow passages in the fourth CMA 24 via the fourth internal introduction duct 34, cooling the fourth CMA 24. The air having cooled the fourth CMA 24 by passing through the fourth CMA 24 flows into the fourth room 14, and is then discharged to the exterior through the fourth discharge duct 54.

As described above, the first, second, third and fourth suction fans 41, 42, 43 and 44 are respectively driven, the air is caused to independently pass through the first, second, third and fourth rooms 11, 12, 13 and 14 by the suction force of each of the suction fans. Thereby, cooling may be performed by the independent air flows.

Since the battery is partitioned into the first, second, third and fourth rooms 11, 12, 13 and 14 and the air flows in the respective rooms do not affect each other, biasing of the air flows to one side may prevented, and accordingly the cooling performance may be improved.

Therefore, the first, second, third and fourth CMAs 21, 22, 23 and 24 may not exhibit temperature difference therebetween, and may be uniformly cooled.

It will be apparent to those skilled in the art that various modifications and variations can be made in the present invention without departing from the spirit or scope of the invention. Therefore, the embodiments described above should be understood as being illustrative, not limitative. Those skilled in the art will appreciate that the scope of the present invention is defined by the accompanying claims rather than by the detailed description given above and the present invention covers the modifications and variations of this invention provided they come within the scope of the appended claims and their equivalents.

### INDUSTRIAL APPLICABILITY

According to embodiments of the present invention, a battery-cooling system with improved cooling performance can be manufactured.

1. A battery-cooling system for an electric vehicle comprising:
a battery provided with a battery case having an interior partitioned into a plurality of rooms, a cell module assembly being mounted in each of the rooms; and
a battery-cooling unit to introduce cool air into each of the rooms and to separately suction the air from each of the rooms and discharge the suctioned air.

2. The battery-cooling system according to claim 1, wherein the battery-cooling unit comprises a plurality of suction fans installed to be respectively connected to the rooms to suction the air having cooled an interior of each the rooms and discharge the suctioned air.

3. The battery-cooling system according to claim 1, wherein the battery-cooling unit comprises:
at least one introduction duct to guide external air into the rooms;
a plurality of discharge ducts respectively connected to the rooms, the discharge ducts being configured to discharge the air having cooled interiors of the rooms; and
a plurality of suction fans respectively installed at the discharge ducts to suction the air having cooled the interior of each of the rooms and discharge the suctioned air.

4. The battery-cooling system according to claim 3, wherein the introduction duct comprises:
an external introduction duct installed at an exterior of the battery case to guide the external air into the battery case; and
an internal introduction duct connected to the external introduction duct and branched in the battery case to be connected to each of the rooms to distribute the external air introduced through the external introduction duct to the rooms.

5. The battery-cooling system according to claim 3, wherein the at least one introduction duct comprises a plurality of introduction ducts respectively connected to the rooms to guide the external air directly to the rooms.

6. The battery-cooling system according to claim 3, wherein the cell module assembly comprises a plurality of cell modules stacked by being spaced a predetermined distance from each other to define air flow passages,
wherein the introduction duct is coupled to the cell module assembly to directly communicate with the flow passages.

7. The battery-cooling system according to claim 6, wherein the discharge ducts are coupled to the rooms.

8. The battery-cooling system according to claim 1, wherein the battery case comprises:
a battery carrier allowing the cell module assemblies to be placed and mounted thereon;
a battery cover provided to an upper side of the battery carrier and partitioned into the plurality of rooms, a partition wall being formed between at least some rooms of the plurality of rooms.
